(19) United States
(12) Patent Application Publication
(10) Pub. No.: US 2011/0298816 A1
(43) Pub. Date: Dec. 8, 2011

(54) UPDATING GRAPHICAL DISPLAY CONTENT

(75) Inventors: Ming Liu, Redmond, WA (US); Raman Narayanan, Seattle, WA (US)

(73) Assignee: Microsoft Corporation, Redmond, WA (US)

(21) Appl. No.: 12/793,242

(22) Filed: Jun. 3, 2010

(51) Int. Cl. G09G 5/00

(52) U.S. Cl. 345/581

(57) ABSTRACT

One or more techniques and/or systems are disclosed for redirecting output of a graphics rich application, such as a video or animation generation program, to a destination display system. Content that is being generated (e.g., dynamically) is intercepted from a graphics rich content generation application that is rendering to a native graphic processing unit (GPU) rendering abstraction layer, by intercepting a rendering call for the content. The intercepted content (first content) is redirected to a native GPU abstraction layer that comprises surface synchronization functionality. Using the native GPU surface synchronization abstraction layer, the intercepted content is synchronized with an output surface that is rendering second graphics content (e.g., pregenerated content).

### BACKGROUND

Graphical content, such as video or animated images, can be displayed on a variety of displays. For example, a typical computer user may view videos or other graphical content on a monitor display. As another example, graphical content can be pre-generated by creating and editing the content, storing it on a storage medium (e.g., disks, memory, tape, flash drive, etc.), then playing it back using a playback device (e.g., multi-media program on a computer, video playback device, etc.). Generating and playing graphics-rich content for a small display, such as on a portable multi-media device, if often quite different than for a large display, such as an electronic billboard. Because graphical content is often generated based on pixels, and frame-rate, it may be difficult to achieve a same video quality (e.g., smoothness of content and sharpness of picture) on a large display as on a small display.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Digital projection systems, such as for large displays, can be used to display graphics rich digital content (e.g., on an electronic billboard or sign). Typically the generation and editing of the content is performed separately from the playback of the generated content. That is, because it is difficult to dynamically generate graphics-rich content for a large display, the content is usually pre-recorded. For example, the content is recorded and played back by a playback engine that renders the content to a display. One reason for separation of these aspects is due to low performance capabilities of display systems in rendering desired frame rates of graphics rich digital content.

Applications may be able generate the graphics rich content to be used for large displays; however, the display systems cannot typically render the content as fast as it is generated. As an example, between frames of content rendered by a display system, the application can generates more content that ends up not being displayed, thereby resulting in choppy animation. One may wish to inject additional graphics rich content into existing graphical content that is being displayed. However, due to the limitations of current display systems, for example, updating the pregenerated content with graphics rich content does not work well, particularly for large displays.

Accordingly, one or more techniques and/or systems are disclosed that provide for capturing graphics rich digital content generated dynamically, and injecting into pre-recorded content being displayed. That is, for example, a user may generate new graphics rich content, that can be captured and integrated, relatively seamlessly, into pregenerated content that is being displayed on a large display. In this way, an electronic billboard that is displaying pre-recorded video content, for example, may be immediately updated with dynamically (on-the-fly) created graphics rich content, such that the displayed content does not suffer from choppy frame rates, for example.

In one embodiment for redirecting output of a graphics-rich application to a destination display system, dynamically generated content from a graphics rich content generation application, which is rendering to a native graphic processing unit (GPU) rendering abstraction layer, is intercepted by intercepting a rendering call, such as from the application to the abstraction layer. The intercepted content (first content) is redirected to a native GPU surface synchronization abstraction layer, such as to a surface of the abstraction layer (e.g., memory areas comprising the graphics rendering information). The intercepted content is synchronized using the native GPU surface synchronization abstraction layer, across a process boundary, with an output surface that is rendering second graphics content (e.g., pre-generated content), such as to a GPU associated with a display.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for redirecting output of a graphic rich application to a destination display system.

FIG. 2 is a diagram illustrating an exemplary embodiment of an implementation of one or more methods for redirecting output of a graphic rich application to a destination display system.

FIG. 3 is a flow diagram illustrating one embodiment of one or more methods for redirecting output of a graphic rich application to a destination display system.

FIG. 4 is a component diagram of a system for redirecting output of a graphic rich application to a destination display system.

FIG. 5 is a component diagram illustrating one embodiment of an implementation of one or more systems described herein.

FIG. 6 is an illustration of an exemplary computer-readable medium comprising processor-executable instructions configured to embody one or more of the provisions set forth herein.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Digital projection systems used to display graphics rich digital content typically separate the editing and playback portions, particularly when the display is a large digital display. That is, for example, when displaying graphics rich digital content on a large display (e.g., electronic billboard), the content is pre-edited and recorded, then a playback engine renders the content to a graphics processing unit (GPU) for display. One reason for separation of these aspects is due to low performance capabilities of display systems in rendering desired frame rates of graphics rich digital content.

For example, applications can generate the graphics rich content faster than the display systems can render the content. That is, as an example, the application generates the content; the display system takes a snapshot of the generated content for display, and then sends it to the GPU for processing to the display device (e.g., screen). The display system takes another snapshot of the generated content, and displays it. However, in this example, between the time of a first snapshot and a second snapshot, the application generates more content that is not accounted for, thereby resulting in choppy animation, for example.

Often, one may wish to inject additional graphics rich content into existing graphical content that is being displayed. However, due to the limitations described above, for example, this does not work well, particularly for large displays. A method may be devised that provides for capturing graphics rich digital content generated dynamically, and injecting that content into pre-recorded content being displayed.

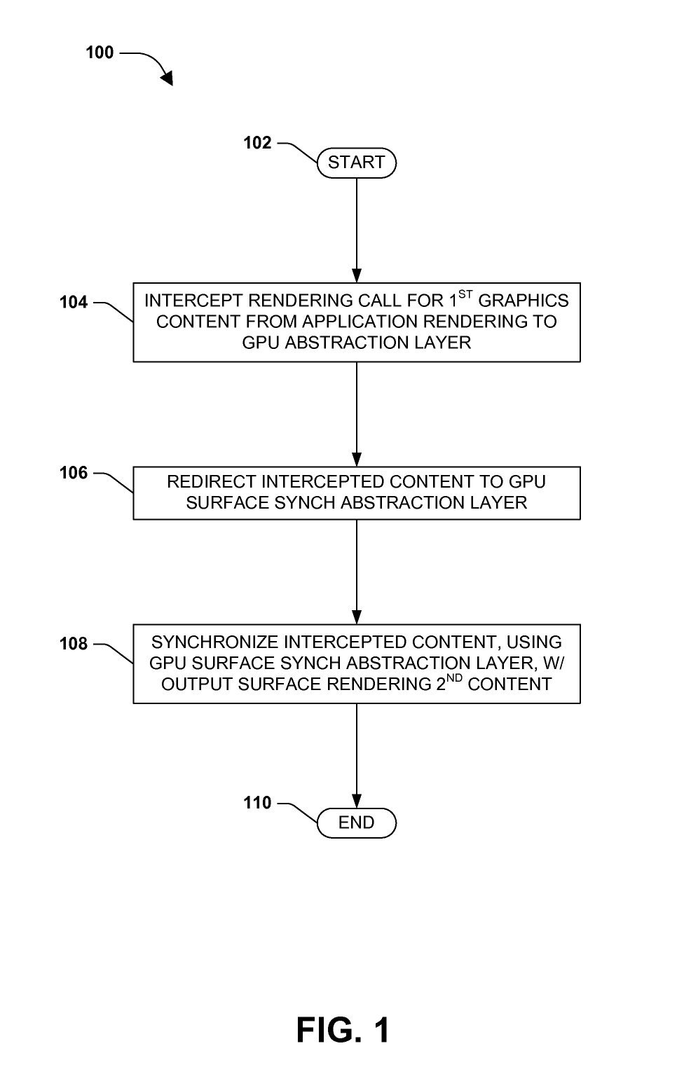

FIG. 1 is a flow diagram of an exemplary method 100 for redirecting output of a graphics rich application to a destination display system. The exemplary method 100 begins at 102 and involves intercepting a rendering call in order to intercept first content from a graphics rich content generation application that is rendering to a native graphic processing unit (GPU) rendering abstraction layer, at 104. In one embodiment, a graphical framework based application (e.g., Windows Presentation Foundation (WPF)), such as a program displaying digital animations, may be rendering the animations to graphics hardware (e.g., a graphics processor, GPU) through an interface, such as a GPU abstraction layer (e.g., comprising one or more application programming interfaces (APIs)), configured for this purpose.

As an example, the native GPU abstraction layer (e.g., native to the machine running the application) can provide an interface to the GPU for applications attempting to render graphics on a coupled display screen (e.g., monitor). In this example, a WPF-based application may be rendering a graphics rich animation to a display, and in doing so, is making rendering calls to the GPU abstraction layer (e.g., DirectX® APIs, or OpenGL APIs). Further, the rendering from the application generating graphics rich content to the GPU can be performed by sending the content to a surface of the GPU abstraction layer. The GPU abstraction layer surface is a memory area that comprises information about the graphics for rendering the content (e.g., information about textured meshes forming a 2D or 3D animation).

In this embodiment, the rendering calls can be intercepted in order to intercept the content being sent to the GPU abstraction layer surface. In one embodiment, a redirecting framework utility can be called (e.g., by the user or an automated process), which intercepts the first content and redirects the first content to a native GPU surface synchronization abstraction layer. In this embodiment, the redirecting framework utility may comprise a process, executable file, a DLL object or some process that intercepts the content for redirection to the GPU surface synchronization abstraction layer.

At 106 in the exemplary method 100, of FIG. 1, the intercepted content is redirected to a native GPU surface synchronization abstraction layer. In one embodiment, the native GPU surface synchronization abstraction layer comprises a GPU interface that can provide for GPU abstraction layer surfaces to be shared across different processes. That is, for example, a first process may be rendering first content to a first GPU, and a second process may be rendering second content to a second GPU. The GPU surface synchronization abstraction layer can provide for sharing of the first content with the second GPU, for example.

At 108, using the native GPU surface synchronization abstraction layer, the intercepted content is synchronized with an output surface that is rendering second graphics content. For example, the GPU surface synchronization abstraction layer can synchronize a first surface and second surface between the different processes. In this embodiment, the surface of the native GPU surface synchronization abstraction layer is synchronized with the surface of the output surface for the second graphical content. In this way, for example, graphics rich first content being generated by the application can be introduced into second content already being rendered to the output. As an example, an application can inject a rendering mesh created by another application into content that it is already being displayed (e.g., pre-recorded content being played back on a display screen).

Having synchronized the intercepted content with an output surface, thereby providing for dynamically generated content to be introduced into pre-recorded content, for example, the exemplary method 100 ends at 110.

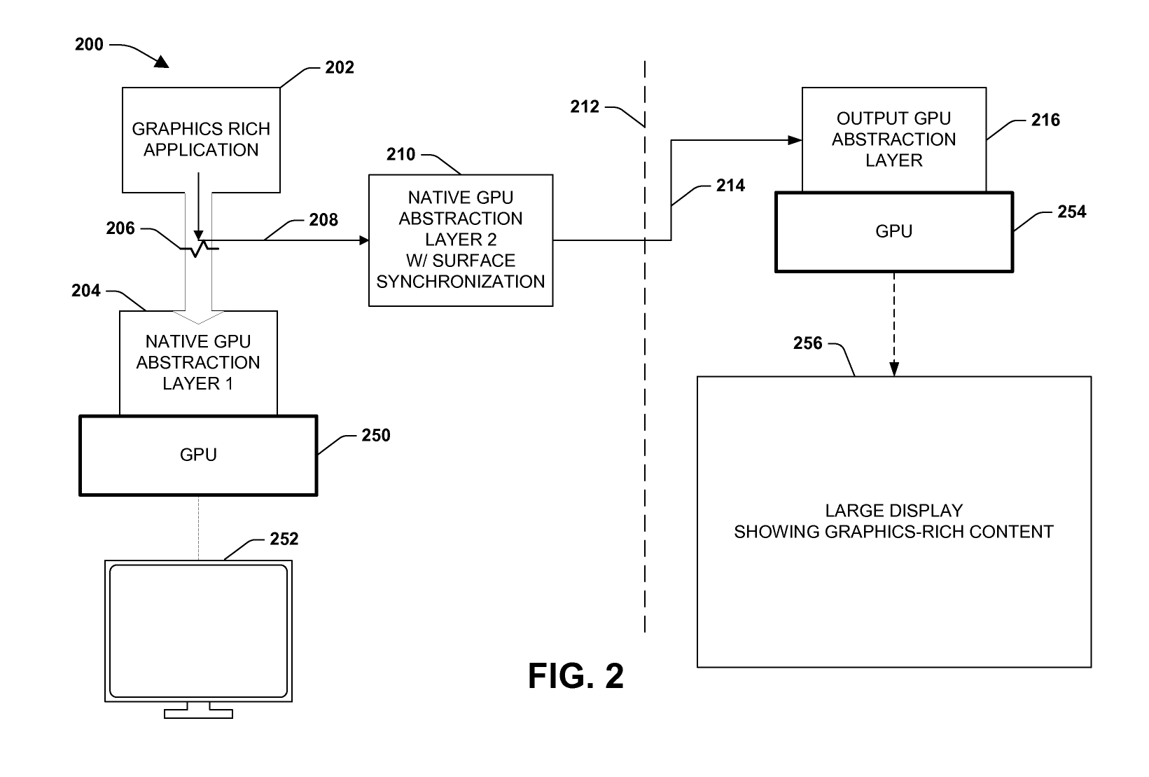

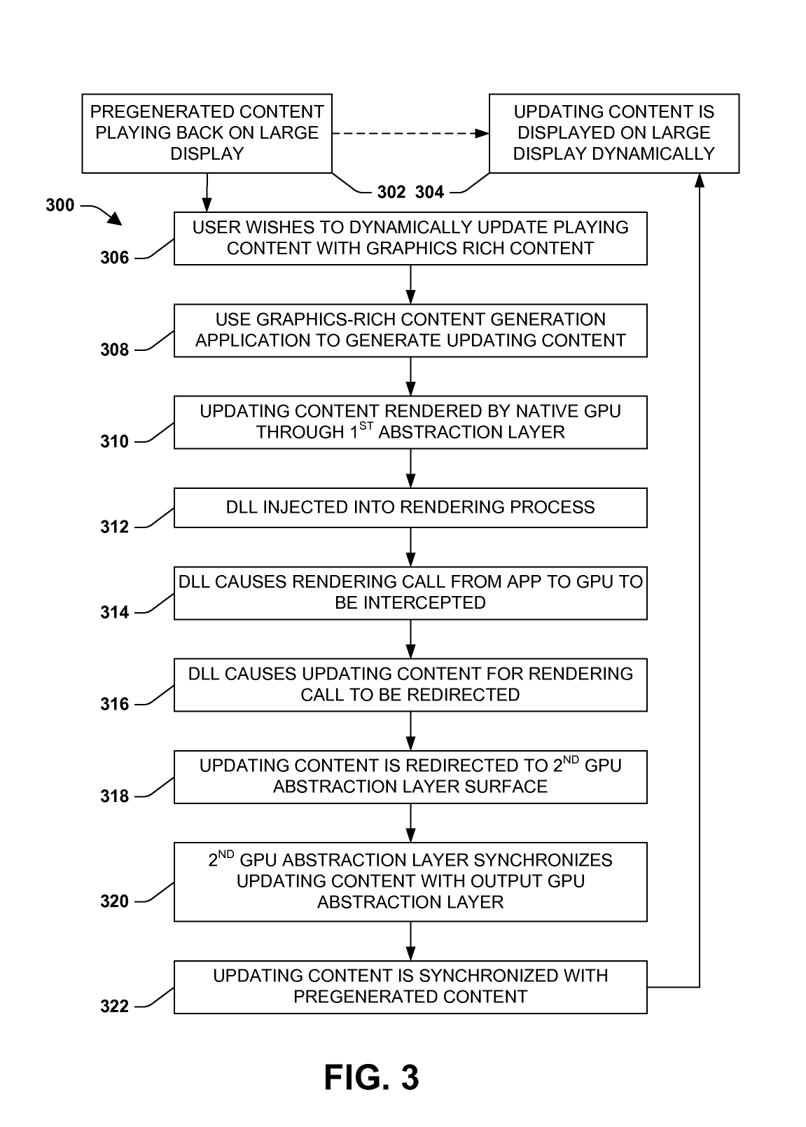

FIG. 2 is a diagram illustrating an exemplary embodiment 200 of an implementation of one or more techniques and/or systems for redirecting output of a graphic rich application to a destination display system. FIG. 3 is a flow diagram illustrating one embodiment 300 of one or more methods for redirecting output of a graphic rich application to a destination display system, which will be discussed in more detail with reference to FIG. 2.

In FIG. 2, a graphics rich application 202 is generating graphical content, which is intended to be received by a first native GPU abstraction layer 204. The first native GPU abstraction layer 204 is an interface for the graphics rich application 202 to the GPU 250, which can render the graphical content generated by the application 202 on a native display 252 (e.g., conventional desktop monitor). A separate process is indicated by a process boundary 212. In one embodiment, the process boundary 212 can indicate a boundary between processes running on a same machine or system, or processes running on different machines or systems.

In this embodiment 200, an output GPU abstraction layer 216, which is acting as an interface to a GPU 254, can receive output content to be displayed on a display 256 that is (substantially) larger than display 252 and that is showing graphics rich content. For example, a display in a retail establishment may be showing video, such as advertisements, entertainment content, and other information that is pre-edited, and pre-recorded. A playback engine can be rendering the pre-recorded content to a surface for the output GPU abstraction layer 216, which interfaces with the GPU 254 for the large display 256. In this example, the retail establishment may wish to inject additional, dynamically generated content (e.g., a sale) into the pre-recorded content showing on the large display 256.

Turning now to FIG. 3, at 302, the pre-generated content is playing back on the large display (e.g., 256). At 306, the user wishes to dynamically update the pre-generated content with graphics rich content. The user can at 308 utilize the graphics rich content generation application 202 (e.g., a WPF-based video generation program) to create the content intended for injection into the pre-generated content. Typically, when content is generated that is intended to be rendered to the native GPU, via the GPU abstraction layer (e.g., 204), the application generating the content makes a rendering call to the native GPU abstraction layer to update the content being rendered (e.g., the app sends a message to the GPU indicating that updating content is ready for rendering).

In this embodiment, at 310, the rendering call is made from the graphics generating application 202 to the first native GPU abstraction layer 204 that the first graphical content is ready for updating. In one embodiment, the graphics generating application 202 is rendering to a surface (e.g., memory area comprising graphics information for rendering) of the first native GPU abstraction layer 204. At 312, a redirecting framework utility can be called, which comprises injecting a dynamic link library (DLL) object 206 into the content from the graphics rich content generation application 202.

A DLL object can be used within the framework, at 314, to intercept the rendering call to update the graphics content from the graphics rich generation application 202. Further, the intercepted call can be directed 208 to a second native GPU abstraction layer 210, which comprises a surface synchronization feature. In this way, at 314, the call to update content is redirected 208 to the second native GPU abstraction layer 210, at 316, and the DLL causes the updated content for the rendering call to also be redirected 208 to a surface of the second native GPU abstraction layer 210, at 318. In this way, for example, the application 202 is configured to make rendering calls to the first native GPU abstraction layer 204, for content to be delivered to the surface of first native GPU abstraction layer, for the native GPU 250. However, the injected DLL (e.g., at 206) causes the rendering calls to be redirected 208 to the second native GPU abstraction layer 210, thereby causing the content from the application 202 to be delivered to the surface of the second native GPU abstraction layer 210.

At 320 in the exemplary embodiment 300, the second native GPU abstraction layer 210, comprising the surface synchronization feature, synchronizes 214 the updated graphics content with a surface for the output GPU abstraction layer 216. In one embodiment, the synchronizing 214 of the intercepted content with the output surface can comprise using a synchronized surface sharing functionality of the native GPU surface synchronization abstraction layer 210 to share the surface of the native GPU surface synchronization abstraction layer 210 with another process, such as the output GPU abstraction layer 216, across the process boundary 212.

In one embodiment, as illustrated in FIG. 2, the other process can comprise a surface of a projection display system. In this embodiment, the output GPU abstraction layer comprises a surface (e.g., memory area comprising graphics rendering information) that receives graphical content from a pre-recorded playback machine, for example. The content is directed to the GPU 254, which provides for the content to be displayed by the projection system (e.g., LCD, LED, CRT, etc.), such as an electronic billboard, video display terminal, etc.

In this embodiment, the content that is dynamically generated by the graphics application 202 can be synchronized 214 with the graphics from the playback machine at the surface of the output GPU abstraction layer 216. In this way, for example, the pre-recorded content can be dynamically updated. As shown in FIG. 3, the updated content from the graphics application 202 is synchronized 214 with the pregenerated content, at 322, as described above, and the updated content is displayed on the large display, dynamically, with the pregenerated content at 304.

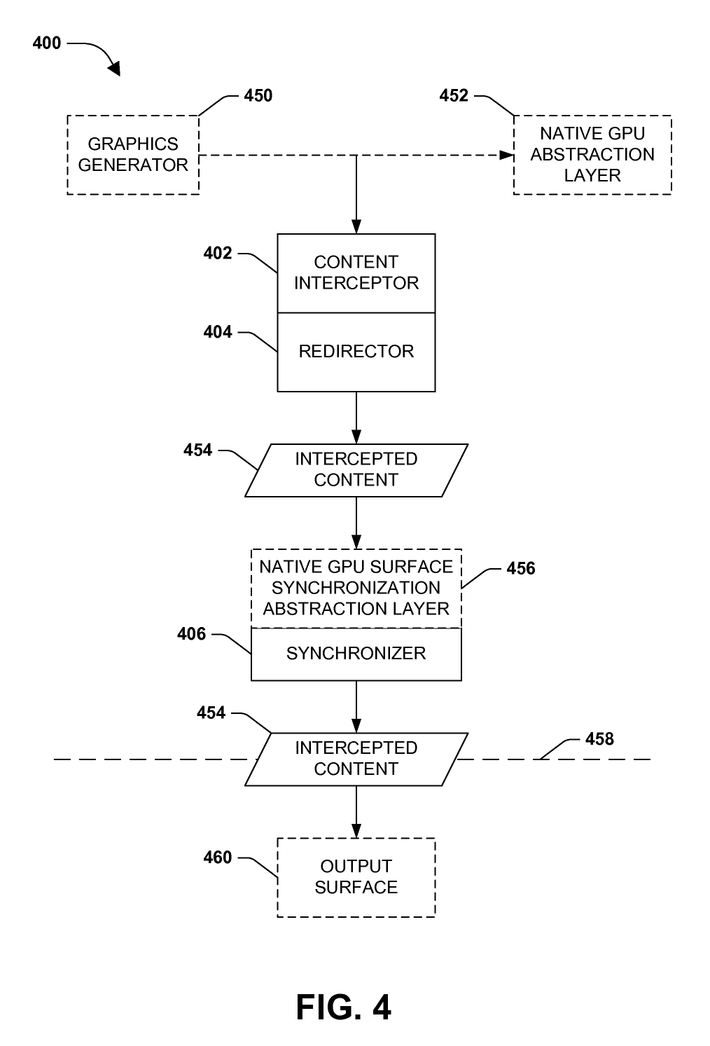

A system may be devised for dynamically updating pre-generated graphical content on a display, such as digitally generated content, with graphics rich digitally generated content. FIG. 4 is a component diagram of a system 400 for redirecting output of a graphic rich application to a destination display system. A content interception component 402 intercepts a first content from a graphics rich content generation application 450 that is rendering to a native graphic processing unit (GPU) rendering abstraction layer 452. In order to intercept the first content, the content interception component 402 intercepts a rendering call, such as from the graphics rich content generation application 450 to the native graphic processing unit (GPU) rendering abstraction layer 452.

A redirection component 404 is operably coupled with the content interception component 402 to redirect the intercepted content 454 to a native GPU surface synchronization abstraction layer 456. A synchronization component 406 is operably coupled with the redirection component 404, and it synchronizes the intercepted content 454 with an output surface 460 that is rendering a second graphics content using the native GPU surface synchronization abstraction layer. In this embodiment, the synchronization component 406 can synchronize the intercepted content with the output surface 460 across a process boundary 458, such as separating two different processes on a same or different machines.

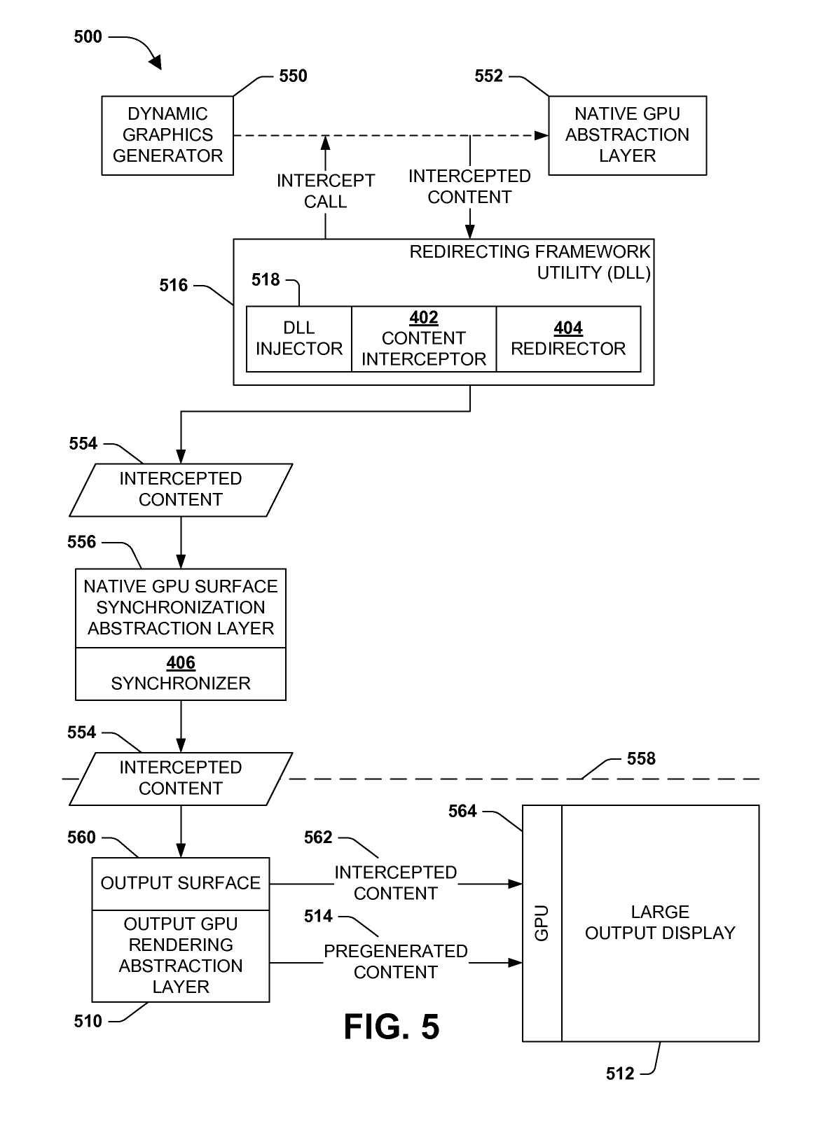

FIG. 5 is a component diagram illustrating one embodiment 500 of an implementation of one or more systems described herein. A redirecting framework utility 516 can intercept first content and redirect the first content (the intercepted content 554) to the native GPU surface synchronization abstraction layer 556. In one embodiment, the redirecting framework utility 516 can comprise a dynamic link library (DLL) object injection component 518 that injects a DLL object into the graphics content generation process from the graphics rich content generation application 550.

In this embodiment, the redirecting framework utility 516 can comprise the DLL object which can intercept the rendering call from the graphics rich content generation application 550 to the native GPU rendering abstraction layer 552 to intercept the first content, such as by using the content interception component 402. Further, the DLL object can redirect the first content (e.g., 554) associated with the rendering call to the native GPU surface synchronization abstraction layer 556, such as by using the redirection component 404.

The output surface 560 can render the intercepted content 562 to an output display component 512, in this embodiment, by using the output GPU rendering abstraction layer 510 to interface with the GPU 564 for the display component 512. Further, the graphics rich content generation application 550 that is rendering to the native GPU rendering abstraction layer 552 can be an application that generates graphics-rich content dynamically (e.g., intercepted content 554) to be dynamically synchronized with the second graphics content, comprising pregenerated content 514. Pregenerated content 514 may be content that is rendered from the output surface, such as provided by a playback engine, to the display component 512.

In one embodiment, in order to synchronize the content, the native GPU surface synchronization abstraction layer 556 shares a first graphics surface (e.g., comprised in 556) across a process boundary 558 with a second graphics surface (e.g., the output surface 560). In one embodiment, the output surface 560 is managed by an output GPU rendering abstraction layer 510, and the output surface 560 comprises memory components that store information for rendering graphics-rich content, such the intercepted content 562 and pregenerated content 514.

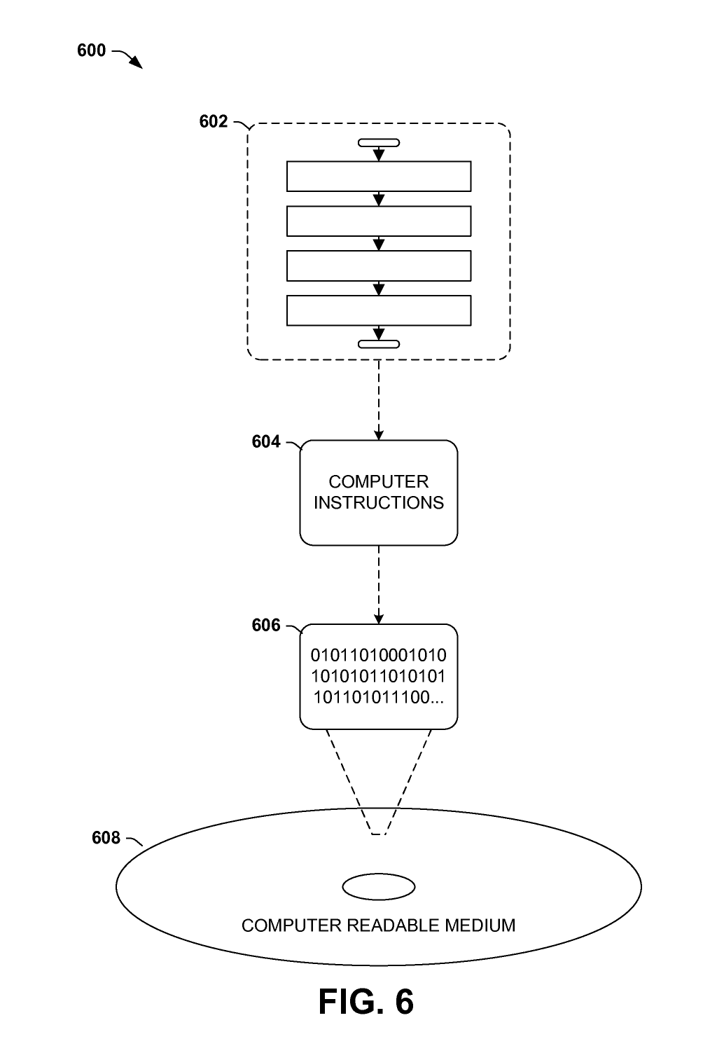

Still another embodiment involves a computer-readable medium comprising processor-executable instructions configured to implement one or more of the techniques presented herein. An exemplary computer-readable medium that may be devised in these ways is illustrated in FIG. 6, wherein the implementation 600 comprises a computer-readable medium 608 (e.g., a CD-R, DVD-R, or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as the exemplary method 100 of FIG. 1, for example. In another such embodiment, the processor-executable instructions 604 may be configured to implement a system, such as the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

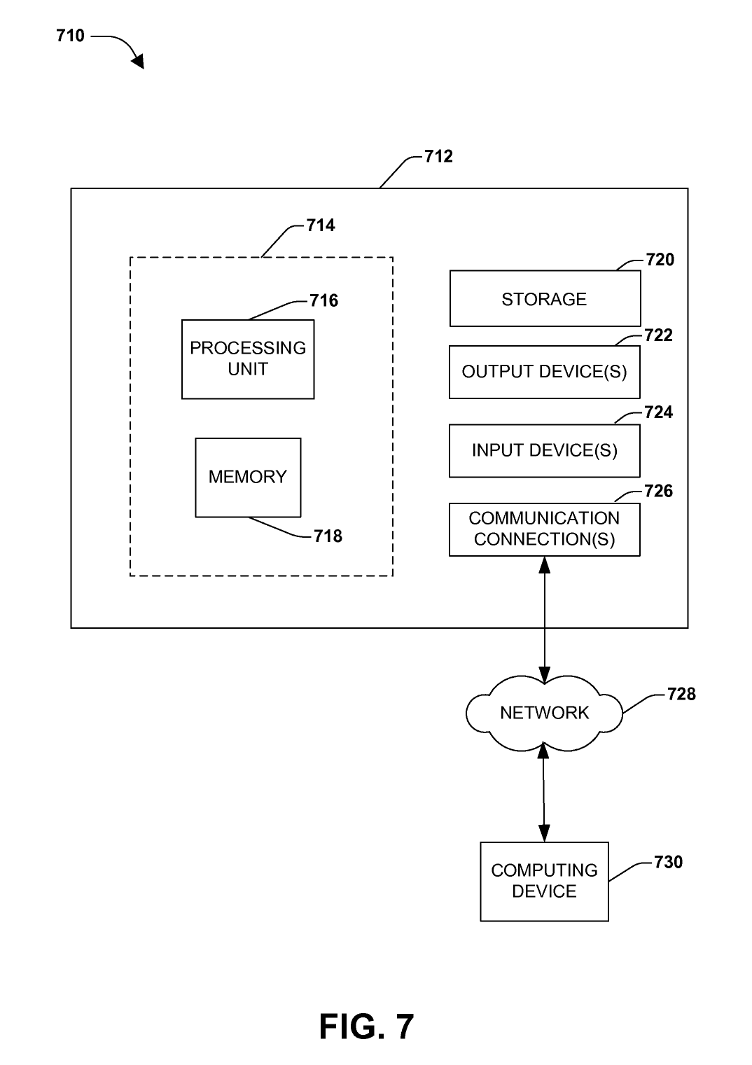

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 710 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices.
Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer-based method for redirecting output of a graphic rich application to a destination display system, comprising:
intercepting first content from a graphics rich content generation application that is rendering to a native graphic processing unit (GPU) rendering abstraction layer, by intercepting a rendering call, using a computer-based processor;
redirecting the intercepted content to a native GPU surface synchronization abstraction layer; and
synchronizing the intercepted content with an output surface that is rendering second graphics content using the native GPU surface synchronization abstraction layer.

2. The method of claim 1, comprising calling a redirecting framework utility to intercept the first content and redirect the first content to the native GPU surface synchronization abstraction layer.

3. The method of claim 2, calling a redirecting framework utility comprising injecting a dynamic link library (DLL) object into the content from the graphics rich content generation application.

4. The method of claim 1, comprising intercepting the rending call from the graphics rich content generation application to the native GPU rendering abstraction layer.

5. The method of claim 1, intercepting first content from a graphics rich content generation application comprising intercepting the first content from the graphics rich content generation application that is rendering to a surface of the native (GPU) rendering abstraction layer.

6. The method of claim 1:
intercepting the first content comprising intercepting a rendering call from the graphics rich content generation application to the native GPU rendering abstraction layer; and
redirecting the first content associated with the rendering call to the native GPU surface synchronization abstraction layer.

7. The method of claim 1, redirecting the intercepted content to the native GPU surface synchronization abstraction layer comprising redirecting the intercepted content to a surface of the native GPU surface synchronization abstraction layer.

8. The method of claim 1, synchronizing the intercepted content with an output surface comprising using a synchronized surface sharing functionality of the native GPU surface synchronization abstraction layer to share a surface of the native GPU surface synchronization abstraction layer with another process.

9. The method of claim 8, sharing the surface of the native GPU surface synchronization abstraction layer with another process comprising sharing the surface with a projection display system surface.

10. The method of claim 1, comprising generating the first content for the graphics rich content generation application for dynamic synchronization with the second content that is rendered by the output surface.

11. A system for redirecting output of a graphic rich application to a destination display system, comprising:
a content interception component configured to intercept a first content from a graphics rich content generation application that is rendering to a native graphic processing unit (GPU) rendering abstraction layer, by intercepting a rendering call;
a redirection component operably coupled with the content interception component, and configured to redirect the intercepted content to a native GPU surface synchronization abstraction layer; and
a synchronization component operably coupled with the redirection component, and configured to synchronize the intercepted content with an output surface that is rendering a second graphics content using the native GPU surface synchronization abstraction layer.

12. The system of claim 11, comprising a redirecting framework utility configured to intercept the first content and redirect the first content to the native GPU surface synchronization abstraction layer.

13. The system of claim 12, the redirecting framework utility comprising a dynamic link library (DLL) object injection component configured to inject a DLL object into the graphics content generation process from the graphics rich content generation application.

14. The system of claim 12, comprising a DLL object configured to:
intercept a rendering call from the graphics rich content generation application to the native GPU rendering abstraction layer to intercept the first content; and
redirect the first content associated with the rendering call to the native GPU surface synchronization abstraction layer.

15. The system of claim 11, comprising an output display component to which the output surface is rendering the second graphics content.

16. The system of claim 11, the graphics rich content generation application that is rendering to the native GPU rendering abstraction layer comprising an application configured to generate graphics-rich content dynamically for dynamic synchronization with the second graphics content.

17. The system of claim 11:
the second graphics content comprising pregenerated content rendered from the output surface to a display; and
the first graphics content comprising dynamically generated graphics-rich content synchronized with the second graphics content.

18. The system of claim 11, the native GPU surface synchronization abstraction layer configured to share a first graphics surface across a process boundary with a second graphics surface.

19. The system of claim 11, the output surface managed by an output GPU rendering abstraction layer, and comprising one or more memory components configured to store information for rendering graphics-rich content.

20. A computer-based method for redirecting output of a graphic rich application to a destination display system, comprising:
calling a redirecting framework utility comprising injecting a dynamic link library (DLL) object into content rendering from a graphics rich content generation application to a surface of a native graphic processing unit (GPU) rendering abstraction layer, the DLL object:
intercepting a first content from the graphics rich content generation application that is rendering to the native GPU rendering abstraction layer, comprising intercepting a rendering call from the graphics rich content generation application to the native GPU rendering abstraction layer;
redirecting the first content associated with the rendering call to a native GPU surface synchronization abstraction layer; and
synchronizing the intercepted content with an output surface that is rendering second graphics content using the native GPU surface synchronization abstraction layer, comprising using a synchronized surface sharing functionality of the native GPU surface synchronization abstraction layer to share a surface of the native GPU surface synchronization abstraction layer with another process.
